(19) United States
(12) Patent Application Publication
(10) Pub. No.: US 2014/0044001 A1
(43) Pub. Date: Feb. 13, 2014

(54) METHOD OF ESTABLISHING COMMUNICATION AND BASE STATION

(71) Applicants: Yuji Akai, Chiyoda-ku (JP); Yoshiyuki Yasuda, Chiyoda-ku (JP); Masafumi Masuda, Chiyoda-ku (JP); Yasuhiro Kanetaka, Chiyoda-ku (JP); Kunihiko Teshima, Chiyoda-ku (JP)

(72) Inventors: Yuji Akai, Chiyoda-ku (JP); Yoshiyuki Yasuda, Chiyoda-ku (JP); Masafumi Masuda, Chiyoda-ku (JP); Yasuhiro Kanetaka, Chiyoda-ku (JP); Kunihiko Teshima, Chiyoda-ku (JP)

(73) Assignee: NTT DOCOMO, INC., Tokyo (JP)

(21) Appl. No.: 14/111,862

(22) PCT Filed: May 22, 2012
(86) PCT No.: PCT/JP2012/063077

§ 371 Date: Oct. 15, 2013

(30) Foreign Application Priority Data
Jun. 1, 2011 (JP) 2011-123412

(51) Int. Cl. H04W 36/30

(52) U.S. Cl. CPC H04W 36/30
USPC 370/252

(57) ABSTRACT

A method of establishing communication in a base station includes measuring quality of a neighbor cell of a measurement-target communication system; and establishing communication in the measurement-target communication system when the measured quality is less than a predetermined threshold. The base station includes a measuring unit configured to measure quality of a neighbor cell of a measurement-target communication system; and a communication establishing unit configured to establish communication in the measurement-target communication system when the measured quality is less than a predetermined threshold.

### TECHNICAL FIELD

The present invention relates to a method of establishing communication and a base station.

### BACKGROUND ART

In mobile communication systems such as a W-CDMA (Wideband Code Division Multiple Access) system and an LTE (Long Term Evolution) system, which are standardized by 3GPP (3rd Generation Partnership Project), small radio base stations (hereinafter referred to as “femto-cell base stations”) have been deployed in order to mainly cover small areas such as indoor spaces, in addition to radio base stations which widely cover outdoor spaces (see 3GPP TS 22.220 V11.1.0 (2011-03)). A cell formed by an outdoor radio base station is referred to as a “macro-cell” and a cell formed by a femto-cell base station is referred to as a “femto-cell”. By deploying femto-cell base stations in homes or small offices, small areas can be covered while inter-cell interference can be reduced. In addition, IP lines for home users can be used at a low cost to connect to radio network controllers. In this manner, with one or more femto-cells, a private area specific to a particular user can be formed. In addition, user-specific services such as different pricing plans for users in femto-cells and additional services specific to femto-cells can be provided.

### DISCLOSURE OF INVENTION

### Problem(s) to be Solved by the Invention

However, a femto-cell base station has the following problems.

Since the femto-cell base station has a small coverage area, a larger number of femto-cell base stations may be deployed compared to radio base stations providing macro-cells. In addition, an SCTP (Stream Control Transmission Protocol) link has to be maintained between the femto-cell base station and an RNC (Radio Network Controller) in order to keep connection to the RNC. As a result, when the number of deployed femto-cell base stations increases, a heavy load will be placed on the RNC.

On the other hand, it is expected that the number of users using LTE services will be smaller than the number of users using W-CDMA services at an early stage of deploying LTE femto-cell base stations, because LTE services typically follow W-CDMA services. For this reason, when an LTE femto-cell base station is deployed in a particular area, there is a likelihood that W-CDMA users are present in and around the particular area. Due to limitation on a place or the like, it will be difficult to deploy an LTE femto-cell base station and a W-CDMA femto-cell base station separately in order to provide services for both LTE users and W-CDMA users. Thus, providing, as a dual femto-cell base station, an LTE femto-cell base station with W-CDMA capabilities is under consideration. A cell formed by a dual femto-cell base station is referred to as a “dual femto-cell”.

A dual femto-cell base station also has the above-mentioned problem of the femto-cell base station. In addition, it can be assumed that W-CDMA capabilities will not be needed among independent W-CDMA/LTE capabilities in the dual femto-cell base station, because service areas are sufficiently provided by neighbor W-CDMA macro-cells, for example. Under the present circumstances, in order to operate the dual femto-cell base station as an LTE femto-cell base station by disabling W-CDMA capabilities in the dual femto-cell base station, it is necessary to input configuration data in the RNC, i.e., in an upper network apparatus, to disable the W-CDMA capabilities. It is difficult to promptly set up configurations for a large number of dual femto-cell base stations.

In view of these problems, it is a general object of the present invention to provide a base station which can enable or disable establishment of communication in a measurement-target communication system (a communication system whose quality is to be measured) based on quality of a neighbor cell.

### Means for Solving the Problem(s)

In one aspect of the present invention, there is provided a method of establishing communication in a base station, including the steps of:

measuring quality of a neighbor cell of a measurement-target communication system; and

establishing communication in the measurement-target communication system when the measured quality is less than a predetermined threshold.

In another aspect of the present invention, there is provided a base station, including:

a measuring unit configured to measure quality of a neighbor cell of a measurement-target communication system; and

a communication establishing unit configured to establish communication in the measurement-target communication system when the measured quality is less than a predetermined threshold.

### Advantageous Effect of the Invention

According to the present invention, establishment of communication in a measurement-target communication system can be enabled or disabled based on quality of a neighbor cell.

### BRIEF DESCRIPTION OF THE DRAWINGS

FIG. 1 shows a configuration of a mobile communication system including a dual femto-cell base station in accordance with an embodiment of the present invention.

FIG. 2 shows a functional block diagram of a typical dual femto-cell base station.

FIG. 3 shows a flowchart of a method of establishing communication in a typical dual femto-cell base station.

FIG. 4 shows a functional block diagram of a dual femto-cell base station in accordance with an embodiment of the present invention.

FIG. 5 shows a flowchart of a method of establishing communication in a dual femto-cell base station in accordance with an embodiment of the present invention.

### DETAILED DESCRIPTION OF THE PREFERRED EMBODIMENTS

A mobile communication system including a femto-cell base station in accordance with an embodiment of the present invention is described below. The femto-cell base station measures quality of a neighbor cell of a measurement-target communication system (a communication system whose quality is to be measured) and establishes communication in the measurement-target communication system when the measured quality is less than a predetermined threshold. Establishment of communication means establishing a link to an upper network apparatus associated with the femto-cell base station so as to provide services in the measurement-target communication system. For example, when the femto-cell base station is a dual femto-cell base station which supports both an LTE communication system and a W-CDMA system, the dual femto-cell base station measures quality of a neighbor cell of the W-CDMA communication system and establishes communication in the W-CDMA communication system when the measured quality is less than a predetermined threshold. In this manner, when a mobile station can receive sufficient services in a macro-cell in the W-CDMA communication system, W-CDMA capabilities of the dual femto-cell base station can be disabled.

In addition, the dual femto-cell base station may include a communication control switch which enables or disables establishment of communication in the W-CDMA communication system. The dual femto-cell base station may also include a measurement control switch which enables or disables measurement of the neighbor cell.

An embodiment of the present invention is described below with reference to the accompanying drawings.

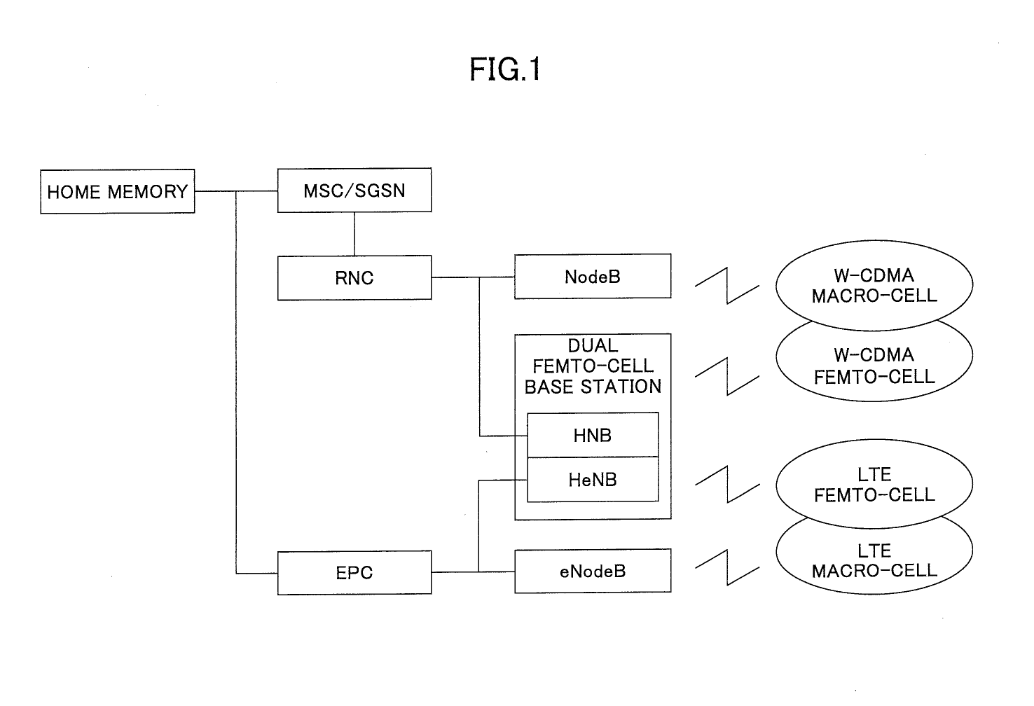

FIG. 1 shows a configuration of a mobile communication system including a dual femto-cell base station in accordance with an embodiment of the present invention.

The mobile communication system includes a home memory for registering and storing subscriber information or the like. The mobile communication system includes a switching center (MSC/SGSN: Mobile Services Switching Center/Serving GPRS Support Node), a radio network controller (RNC), and a W-CDMA radio base station (NodeB) to provide communication services in a W-CDMA communication system. A cell formed by the W-CDMA radio base station is referred to as a “W-CDMA macro-cell”.

In addition, the mobile communication system includes an LTE core network (EPC: Evolved Packet Core) and an LTE radio base station (eNodeB) to provide communication services in an LTE communication system. A cell formed by the LTE radio base station is referred to as a “LTE macro-cell”.

The mobile communication system also includes a dual femto-cell base station (HNB/HeNB) which supports both the LTE communication system and the W-CDMA communication system. The dual femto-cell base station includes a W-CDMA functional unit (HNB) and an LTE functional unit (HeNB). The W-CDMA functional unit is connected to the RNC as an upper network apparatus and the LTE functional unit is connected to the EPC as an upper network apparatus. The dual femto-cell base station covers a smaller area than a typical W-CDMA radio base station or a typical LTE radio base station.

While there are typically a plurality of W-CDMA radio base stations, a plurality of LTE radio base stations, a plurality of dual femto-cell base stations, and a plurality of switching centers connected to one another, only respective ones of them are shown for simplicity. In addition, functionalities of the radio network controller may be physically included in the radio base station or the switching center and the radio network controller may not always physically exist.

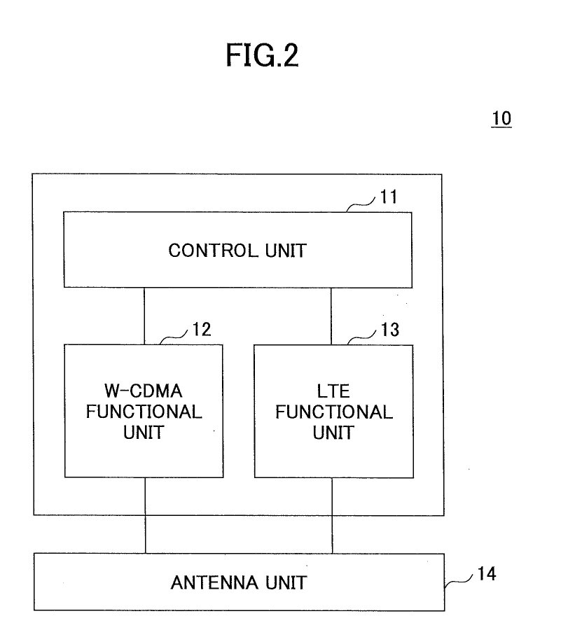

FIG. 2 shows a functional block diagram of a typical dual femto-cell base station 10.

The dual femto-cell base station 10 includes an independent W-CDMA functional unit 12 and an independent LTE functional unit 13, each of which is connected to a common control unit 11 and an antenna 14.

The W-CDMA functional unit 12 authenticates a connection and establishes communication in order to provide services in a W-CDMA communication system. Authentication of a connection means verifying between the W-CDMA functional unit 12 and the RNC whether the connection from the dual femto-cell base station 10 to the RNC is allowed. Establishment of communication means establishing a link to the RNC so as to provide services in the W-CDMA communication system. The W-CDMA functional unit 12 also transmits and receives control information and data between the RNC and the mobile station so as to provide services in the W-CDMA communication system.

The LTE functional unit 13 authenticates a connection and establishes communication in order to provide services in an LTE communication system. Authentication of a connection means verifying between the LTE functional unit 13 and the EPC whether the connection from the dual femto-cell base station 10 to the EPC is allowed. Establishment of communication means establishing a link to the EPC so as to provide services in the LTE communication system. The LTE functional unit 13 also transmits and receives control information and data between the EPC and the mobile station so as to provide services in the LTE communication system.

The control unit 11 controls operations in the W-CDMA functional unit 12 and the LTE functional unit 13. For example, the control unit 11 instructs the W-CDMA functional unit 12 and the LTE functional unit 13 to authenticate a connection and establish communication on startup of the dual femto-cell base station 10.

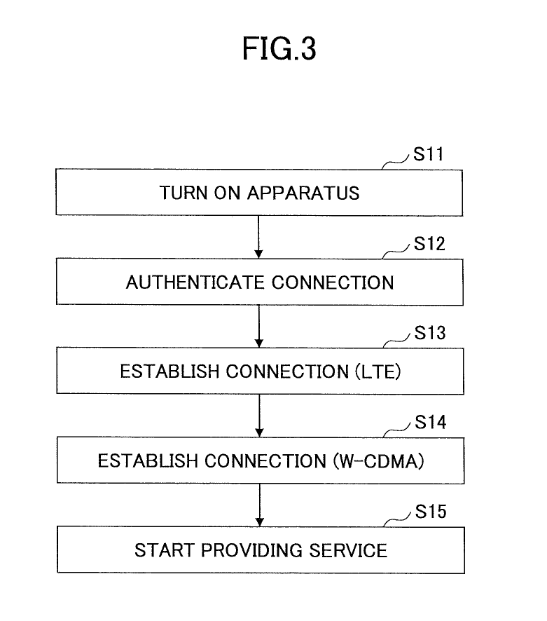

FIG. 3 shows a flowchart of a method of establishing communication in a typical dual femto-cell base station. This method of establishing communication is performed according to an instruction from the control unit 11 to the W-CDMA functional unit 12 and the LTE functional unit 13 shown in FIG. 2, for example.

In order to start up the dual femto-cell base station, the dual femto-cell base station is turned on after deployment (S11). A connection is authenticated such that only dual femto-cell base stations allowed by the radio network controller can make a connection (S12). Then, communication is established in the LTE communication system and the W-CDMA communication system (S13, S14). It should be noted that the steps S13 and S14 may be performed in inverse order or at the same time. Then, services are provided in the LTE communication system and the W-CDMA communication system (S15).

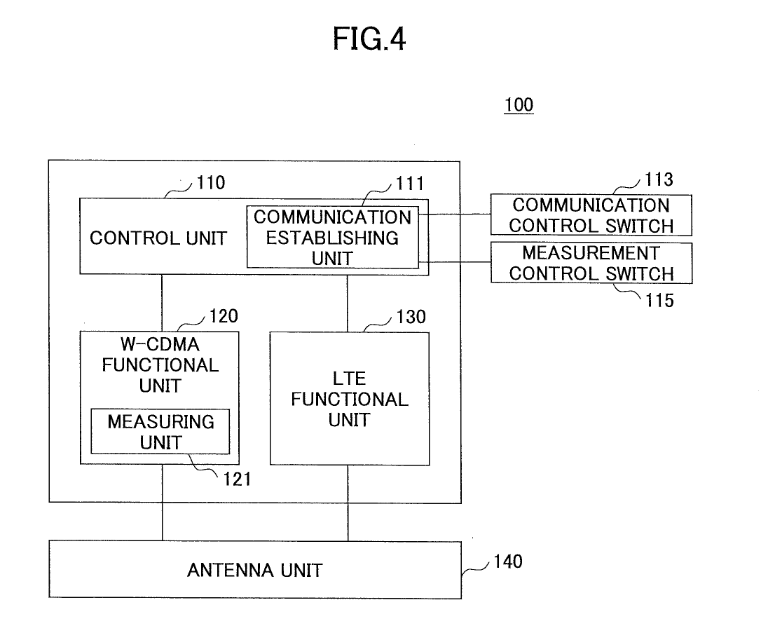

FIG. 4 shows a functional block diagram of a dual femto-cell base station 100.

The dual femto-cell base station 100 includes an independent W-CDMA functional unit 120 and an independent LTE functional unit 130, each of which is connected to a common control unit 110 and an antenna 140 in a similar manner to the dual femto-cell base station 10 shown in FIG. 2.

As described above with reference to FIG. 2, the W-CDMA functional unit 120 performs authentication of a connection, establishment of communication, and transmission and reception of control information and data so as to provide services in the W-CDMA communication system. The LTE functional unit 130 performs authentication of a connection, establishment of communication, and transmission and reception of control information and data so as to provide services in the LTE communication system. The control unit 110 controls operations in the W-CDMA functional unit 120 and the LTE functional unit 130.

The W-CDMA functional unit 120 includes a measuring unit 121. The measuring unit 121 measures received quality of a pilot channel (CPICH: Common Pilot Channel) transmitted in each of cells by the corresponding W-CDMA radio base station. It should be noted that the received quality may be measured using a channel or a signal other than the pilot channel.

The control unit 110 includes a communication establishing unit 111. The communication establishing unit 111 compares the received quality measured by the measuring unit 121 to a predetermined threshold. When the measured received quality is less than the predetermined threshold, the communication establishing unit 111 establishes own base station communication in the W-CDMA communication system. In this manner, when a mobile station can receive sufficient services in a macro-cell in the W-CDMA communication system, own base station communication in the W-CDMA communication system can be disabled. The predetermined threshold used in the communication establishing unit 111 may be configured in advance in firmware of the dual femto-cell base station or may be provided in advance by the RNC and stored in the dual femto-cell base station.

The dual femto-cell base station 100 may further include a communication control switch 113. The communication control switch 113 can arbitrarily determine whether own base station communication is to be established in the W-CDMA communication system. When communication is to be established in the W-CDMA communication system by establishing a link to the RNC, the communication control switch 113 is turned on (active). When a link to the RNC is not to be established and own base station communication is not to be established in the W-CDMA communication system, the communication control switch 113 is turned off (inactive).

The dual femto-cell base station 100 may further include a measurement control switch 115. The measurement control switch 115 can arbitrarily determine whether received quality of the pilot channel is to be measured. When received quality of the pilot channel is to be measured, the measurement control switch 115 is turned on (active). When received quality of the pilot channel is not to be measured, the measurement control switch 115 is turned off (inactive). When the communication control switch 113 is turned off, that is, when communication is not to be established in the W-CDMA communication system, received quality of the pilot channel may not be measured even if the measurement control switch 115 is turned on.

The communication control switch 113 and the measurement control switch 115 may be physical switches which can be manipulated by a user or may be a flag (for example, 0=off, 1=on) on logical data written in a physical memory. In addition, the flag may be static data or configurable data which can be modified by a remote operation or a predetermined algorithm.

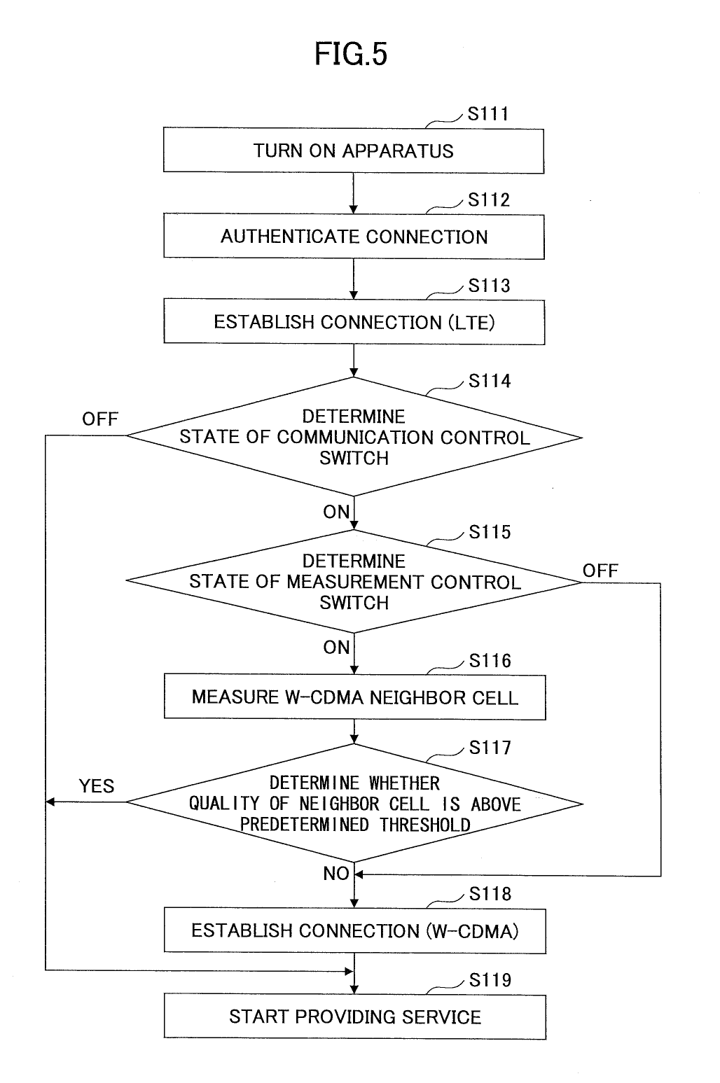

FIG. 5 shows a flowchart of a method of establishing communication in a dual femto-cell base station in accordance with an embodiment of the present invention. This method of establishing communication is performed according to an instruction from the control unit 110 to the W-CDMA functional unit 120 and the LTE functional unit 130 shown in FIG. 4, for example.

As described above with reference to FIG. 3, in order to start up the dual femto-cell base station, the dual femto-cell base station is turned on after deployment (S111). A connection is authenticated such that only dual femto-cell base stations allowed by the radio network controller can make a connection (S112). Then, communication is established by the LTE functional unit 130 (S113). Next, the control unit 110 obtains the state of the communication control switch 113 (S114). When the state of the communication control switch 113 is off (S114: OFF), that is, when communication is not to be established in the W-CDMA communication system, the W-CDMA functional unit 120 does not establish communication. As a result, services are provided by the LTE functional unit (S119).

When the state of the communication control switch 113 is on (S114: ON), that is, when communication is to be established in the W-CDMA communication system, the control unit 110 obtains the state of the measurement control switch 115 (S115). When the state of the measurement control switch 115 is off (S115: OFF), that is, when received quality of the pilot channel is not to be measured, the W-CDMA functional unit 120 establishes communication (S118). As a result, services are provided by the W-CDMA functional unit 120 and the LTE functional unit 130 (S119). In this manner, when the state of the communication control switch 113 is on and when the state of the measurement control switch 115 is off, services are provided by the W-CDMA functional unit 120 and the LTE functional unit 130 regardless of the presence or absence of neighbor macro-cells.

When the state of the measurement control switch is on (S115: ON), that is, when received quality of the pilot channel is to be measured, the measuring unit 121 measures received quality of the pilot channel (S116). When the measured received quality is less than a predetermined threshold (S117: NO), the communication establishing unit 111 determines that the dual femto-cell base station is not within service areas of neighbor macro-cells in the W-CDMA communication system, and then the W-CDMA functional unit 120 establishes communication (S118). As a result, services are provided by the W-CDMA functional unit 120 and the LTE functional unit 130 (S119).

When the measured received quality is more than or equal to the predetermined threshold (5117: YES), the communication establishing unit 111 determines that the dual femto-cell base station is within service areas of neighbor macro-cells in the W-CDMA communication system, and then W-CDMA functional unit 120 does not establish communication. As a result, services are provided by the LTE functional unit 130 (S119).

In a similar manner to the flowchart shown in FIG. 3, the steps 5113 and S114-S118 in FIG. 5 may be performed in inverse order or at the same time. In addition, while FIG. 5 shows that the dual femto-cell base station 100 includes both the communication control switch 113 and the measurement control switch 115, the dual femto-cell base station 100 may not include the communication control switch 113 or the measurement control switch 115. When the dual femto-cell base station 100 does not include the communication control switch 113, the state of the communication control switch 113 may be treated as always on. Similarly, when the dual femto-cell base station 100 does not include the measurement control switch 115, the state of the measurement control switch 115 may be treated as always on.

It should be noted that the start-up of the dual femto-cell base station is not limited to physical turn-on, but includes start-up associated with restart by control from an upper network apparatus or autonomous restart by the dual femto-cell base station. Furthermore, whether establishment of communication in the W-CDMA communication system should be enabled or disabled may be determined at a predetermined trigger such as expiration of a periodic timer in a similar manner to the procedure shown in FIG. 5 in addition to at the start-up or restart of the dual femto-cell base station.

While the embodiments of the dual femto-cell base station including the W-CDMA functional unit and the LTE functional unit have been described above, the present invention can be applicable to any other base station including a femto-cell base station.

For convenience of explanation, the apparatus according to the embodiments of the present invention has been described with reference to functional block diagrams, but the apparatus may be implemented in hardware, software, or combinations thereof. In addition, two or more embodiments or modifications may be combined as appropriate.

For convenience of explanation, the method according to the embodiments of the present invention has been described with reference to flowcharts or sequence diagrams, but the method may be implemented in a sequence different from the sequence shown in the embodiments.

### Effects of Embodiments

According to an embodiment of the present invention, establishment of communication in a measurement-target communication system can be disabled based on quality of a neighbor cell without inputting configuration data in an upper network apparatus.

Specifically, a dual femto-cell base station can disable own communication in the W-CDMA communication system without configuration of the upper network apparatus, by measuring quality of a neighbor cell and determining whether the location where the dual femto-cell base station is placed is within W-CDMA service areas. As a result, resources in the upper network apparatus can be saved.

In addition, with a communication control switch, the dual femto-cell base station can arbitrarily control establishment of communication in the W-CDMA control system. Furthermore, with a measurement control switch, the dual femto-cell base station can enable the measurement capability even though services are sufficiently provided by neighbor W-CDMA macro-cells, thereby flexible operations can be achieved.

While the embodiments of the base station and the method of establishing communication which can enable or disable establishment of communication in a measurement-target communication system based on quality of a neighbor cell have been described above, the present invention is not limited to the these embodiments, and variations, modifications, alterations, and substitutions can be made by those skilled in the art without deviating from the spirit of the present invention.

The present international application is based on and claims the benefit of priority of Japanese Patent Application No. 2011-123412 filed on Jun. 1, 2011, the entire contents of which are hereby incorporated by reference.

### DESCRIPTION OF NOTATIONS

100 dual femto-cell base station

110 control unit

111 communication establishing unit

113 communication control switch

115 measurement control switch

120 W-CDMA functional unit

121 measuring unit

130 LTE functional unit

140 antenna unit

1. A method of establishing communication in a base station, comprising the steps of:
measuring quality of a neighbor cell of a measurement-target communication system; and
establishing communication in the measurement-target communication system when the measured quality is less than a predetermined threshold.

2. The method of claim 1, further comprising the step of:
obtaining a state of a measurement control switch which enables or disables measurement of the quality of the neighbor cell of the measurement-target communication system;
wherein the step of measuring comprises measuring the quality of the neighbor cell when the state of the measurement control switch is on.

3. The method of claim 1, further comprising the step of:
obtaining a state of a communication control switch which enables or disables establishment of communication in the measurement-target communication system;
wherein the step of measuring comprises measuring the quality of the neighbor cell when the state of the communication control switch is on, and
the step of establishing comprises establishing communication in the measurement-target communication system when the state of the communication control switch is on.

4. The method of claim 1,
wherein the step of establishing comprises establishing communication in the measurement-target communication system when the measured quality is less than the predetermined threshold provided by an upper network apparatus associated with the base station.

5. A base station, comprising:
a measuring unit configured to measure quality of a neighbor cell of a measurement-target communication system; and
a communication establishing unit configured to establish communication in the measurement-target communication system when the measured quality is less than a predetermined threshold.
